(19) United States
(12) Patent Application Publication
(10) Pub. No.: US 2026/0103658 A1
(43) Pub. Date: Apr. 16, 2026

(54) DETERGENT COMPOSITION WITH IMPROVED CHLORINE SCAVENGING FOR COLOR PROTECTION

(71) Applicant: Henkel AG & Co. KGaA, Duesseldorf (DE)

(72) Inventors: Daniel Thomas Piorkowski, Fairfield, CT (US); Kyle Seamus Joseph O’Connor, Stamford, CT (US); Napaporn Komesvarakul Slattery, Monroe, CT (US); Yolanda Lunn Li, Stamford, CT (US)

(21) Appl. No.: 19/355,703

(22) Filed: Oct. 10, 2025

Related U.S. Application Data
(60) Provisional application No. 63/707,178, filed on Oct. 14, 2024.

(51) Int. Cl. C11D 3/30; C11D 1/14; C11D 3/00; C11D 3/33; C11D 17/04

(52) U.S. Cl. CPC C11D 3/30; C11D 1/143; C11D 3/0036; C11D 3/33; C11D 17/043; C11D 2111/12

(57) ABSTRACT

The present disclosure provides laundry detergent compositions including a combination of two chlorine scavengers, at least one surfactant and a carry-over enhancer that synergistically work to scavenge in both the wash and rinse cycles. The carry-over enhancer increases the amount of the scavengers that survive the wash cycle allowing more of the chlorine in the rinse cycle to be scavenged.

### CROSS REFERENCE TO RELATED APPLICATION

This application claims benefit of priority to U.S. Provisional Application Ser. No. 63/707,178 filed Oct. 14, 2024, the entire content of which is incorporated herein by reference.

### BACKGROUND

The present disclosure generally relates to fabric laundering, and more particularly to a laundry detergent composition (liquid or unit dose form) that contains two chlorine scavengers and a method of using the same.

In the United States, municipal water is chlorinated with hypochlorite as part of the disinfection process. While this has brought many benefits, it is also a major cause of textile color fading during the laundry process. Many dyes react with hypochlorite in the water which results in a bleaching/fading effect as early as the first wash. This exposure to chlorinated water occurs during both the wash cycle and rinse cycle of the laundry process. Although technologies exist to scavenge chlorine in the wash cycle, carry-over into the rinse cycle has not been identified.

### SUMMARY

The present disclosure provides laundry detergent compositions including a combination of two chlorine scavengers, at least one surfactant and a carry-over enhancer that synergistically work to scavenge chlorine in both the wash cycle and the rinse cycle. The carry-over enhancer increases the amount of the scavengers that survive the wash cycle allowing more of the chlorine in the rinse cycle to be scavenged. This can be measured directly through chlorine present in the rinse cycle, as well as decreased color fading on textiles.

In one aspect of the present disclosure, a liquid (i.e., non-unit dose) laundry detergent composition is provided. In one embodiment, the liquid laundry detergent composition comprises, consists essentially of, or consists of, (a) monoethanolamine (MEA) as a first chlorine scavenger; (b) a second chlorine scavenger which is compositionally different from the first chlorine scavenger; (c) at least one surfactant; (d) a carry-over enhancer; and (e) water.

In another aspect of the present disclosure, a unit dose laundry detergent composition is provided. In one embodiment, the unit dose laundry detergent composition comprises, consists essentially of, or consists of, a pre-determined dose of a laundry detergent composition encapsulated in a container, wherein the laundry detergent composition comprises, consists essentially of, or consists of, (a) monoethanolamine (MEA) as a first chlorine scavenger; (b) a second chlorine scavenger which is compositionally different from the first chlorine scavenger; (c) at least one surfactant; (d) a carry-over enhancer; and (e) water, where the container comprises a water-soluble polymer or water-dispersible polymer.

In the liquid laundry detergent composition and in the unit dose laundry detergent composition, a weight ratio of the first chlorine scavenger to the second chlorine scavenger can be from about 10:1 to about 1:2.

In the liquid laundry detergent composition and in the unit dose laundry detergent composition, a weight ratio of the at least one surfactant to the carry-over enhancer can be from about 35:1 to about 5:1.

In the liquid laundry detergent composition and in the unit dose laundry detergent composition, the chlorine scavenger is an amino acid, a sugar amide, a peptide or any combination thereof.

In the liquid laundry detergent composition and in the unit dose laundry detergent composition, the chlorine scavenger is lysine or threonine.

In the liquid laundry detergent composition and in the unit dose laundry detergent, the carry-over enhancer can be present in an amount from about 0.1 weight percent to about 5 weight percent.

In the liquid laundry detergent composition and in the unit dose laundry detergent composition, the carry-over enhancer is a performance polymer, a soil release polymer, an anti-redeposition polymer or any combination thereof.

In the liquid laundry detergent composition and in the unit dose laundry detergent composition, the surfactant can be present in an amount from about 5 weight percent to about 70 weight percent.

In the liquid laundry detergent composition and in the unit dose laundry detergent composition, the surfactant is an anionic surfactant.

In the liquid laundry detergent composition embodiment, the composition contains at least 20 percent by weight and up to 95 percent by weight water.

In the unit dose laundry detergent composition embodiment, the composition contains at least 5 percent by weight to 45 percent by weight water.

### DETAILED DESCRIPTION

The present disclosure will now be described in greater detail by referring to the following discussion and drawings that accompany the present disclosure. In the following description, numerous specific details are set forth, such as particular structures, components, materials, dimensions, processing steps and techniques, in order to provide an understanding of the various embodiments of the present disclosure. However, it will be appreciated by one of ordinary skill in the art that the various embodiments of the present disclosure may be practiced without these specific details. As used throughout the present disclosure, the term “about” generally indicates no more than ±10%, ±5%, ±2%, ±1% or ±0.5% from a number. When a range is expressed in the present disclosure as being from one number to another number (e.g., 20 to 40), the present disclose contemplates any numerical value that is within the range (i.e., 22, 24, 26, 28.5, 31, 33.5, 35, 37.7, 39 or 40) or any in amount that is bounded by any of the two values that can be present within the range (e.g., 28.5-35).

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising”, when used in this disclosure, specify the presence of stated features, integers, steps, operations, elements, and/or components, but do not preclude the presence or addition of one or more other features, integers, steps, operations, elements, components, and/or groups thereof.

The present disclosure provides laundry detergent compositions containing a combination of at least two chlorine scavengers, at least one surfactant and a carry-over enhancer that synergistically work to scavenge in both the wash and rinse cycles. The carry-over enhancer increases the amount of the two scavengers that survive the wash cycle allowing more of the chlorine in the rinse cycle to be scavenged. This can be measured directly through chlorine present in the rinse cycle, as well as decreased color fading on textiles.

Monoethanolamine (MEA) is an effective chlorine scavenger that synergistically works with an anionic surfactant (linear alkyl benzenesulfonate (LAS) and a carry-over enhancer. To provide sufficient chlorine scavenging in the rinse, a dose as high as 1 to 3% of MEA is needed in the detergent. This amount of MEA may cause discoloration of the detergent such as yellowing over time as well as reduced viscosity to a water-thin level, which consumers may perceive as an indicator of poor cleaning performance.

Amino Acids such as lysine can be added to the formula to decrease the amount of MEA needed to provide a carry-over effect to the rinse. Compared to MEA, lysine does not impart as much yellowing to the detergent over time and does not reduce viscosity.

In other words, the combination of at least two chlorine scavengers and a carry-over enhancer provides rinse cycle benefits while maintaining a color and viscosity aesthetic that appeals to the consumer.

The ability of two chlorine scavengers to work with the carry-over enhancer, and maintain retention on the fabric such that they can even survive the wash cycle is a non-obvious effect of the present disclosure.

In one embodiment, a liquid laundry detergent composition is provided that comprises, consists essentially of, or consists of, (a) monoethanolamine (MEA) as a first chlorine scavenger; (b) a second chlorine scavenger which is compositionally different from the first chlorine scavenger; (c) at least one surfactant; (d) a carry-over enhancer; and (e) water. In another embodiment, a unit dose laundry detergent composition is provided that includes a pre-determined dose of a laundry detergent composition encapsulated in a container, where the laundry detergent composition comprises, consists essentially of, or consists of, (a) monoethanolamine (MEA) as a first chlorine scavenger; (b) a second chlorine scavenger which is compositionally different from the first chlorine scavenger; (c) at least one surfactant; (d) a carry-over enhancer; and (d) water, where the container comprises a water-soluble polymer or water-dispersible polymer.

There are two parts of laundry detergent compositions of the present disclosure: (1) at least two chlorine scavengers tested at different ratios to each other; and (2) enhancement of their rinse scavenging ability with the addition the carry-over enhancer.

With regards to (1), all laundry detergent compositions were able to scavenge chlorine in the rinse (based on chlorine test strips) and the effect on color swatches could also be measured/pictured. The laundry detergent compositions were designed based on delivery of raw materials to the wash liquor so composition percentages will fluctuate depending on chassis type and dose size. Scavenging ability was not dependent on enzymes, dyes, or fragrances, these are all optional additions to the composition.

With regards to (2), beyond just inclusion of ingredients that can scavenge chlorine, there is a synergistic effect between ingredients that deposit onto the fabric and carry-over of chlorine scavengers from the wash cycle to the rinse cycle. For example, polymers that are often added to laundry compositions to help with anti-redeposition and soil-release, can survive the wash cycle into the rinse cycle and in doing so, increase the amount of chlorine scavenger carried into the rinse cycle.

As stated above, the laundry detergent composition (liquid or unit dose form) of the present disclosure includes monoethanolamine (MEA) as a first chlorine scavenger. The term “chlorine scavenger” is used throughout the present disclosure to denote a substance that reacts with chlorine or its sources to reduce or eliminate its harmful effects. The chlorine scavengers remove free and chemically combined chlorine from a water source that contains chlorine.

In the present disclosure, the laundry detergent composition (liquid or unit dose form) can include from about 0.025 percent by weight to about 2 percent by weight of the first chlorine scavenger. In some embodiments, the laundry detergent composition (liquid or unit dose form) of the present disclosure includes from about 0.05 weight percent to about 1.5 weight percent of the first chlorine scavenger. In the present disclosure, all weight percents are based on the total weight of the laundry detergent composition (liquid or unit dose form) unless otherwise specified.

As stated above, the laundry detergent composition (liquid or unit dose form) of the present disclosure includes a second chlorine scavenger which is compositionally different from the first chlorine scavenger. The second chlorine scavenger that can be used in the present disclosure includes any non-MEA chlorine scavenger that can be used to remove/eliminate chlorine during the wash cycle. The second chlorine scavenger can include a single second chlorine scavenger or a combination of two or more second chlorine scavengers can be employed in the laundry detergent composition of the present disclosure. Exemplary second chlorine scavengers include, but are not limited to, an amino acid, a sugar amine, a peptide or any combination thereof.

An amino acid is an organic compound that contains both amino and carboxylic functional groups. Illustrative examples of amino acids that can be used as chlorine scavengers in the present disclosure include alanine, arginine, asparagine, aspartate, cysteine, glutamine, glutamate, glycine, histidine, isoleucine, lysine, methionine, phenylalanine, proline, serine, threonine, tryptophan, tyrosine, valine, or any combination thereof. The amnio acids can be in any stereoisomeric configuration (i.e., the D or L form of the amino acid can be used). In some preferred embodiments, the amino acid that is used for the second chlorine scavenging is lysine or threonine.

The term “sugar amine’ is used in the present disclosure to denote a sugar molecule in which a hydroxyl group has been replaced with an anime group. In the present disclosure, the term “sugar amine” can be used interchangeably used with the term “amino sugar”. In the present disclosure, the sugar amine that can be used for chlorine scavenging includes, but is not limited to, glucosamine, glucose diamine, sorbitol amine, N-acetyl glucosamine, mannosamine, N-acetyl mannosamine, galactosamine, N-acetyl galactosamine or any combination thereof. In some preferred embodiments, the sugar amine that is used for the second chlorine scavenging is glucosamine.

The term “peptide” is used through the present disclosure to denote an organic molecule that includes chains of amino acids linked by peptide bonds. A peptide bond is an amide type chemical bond linking two consecutive alpha amino acids from C1 (carbon number one) of one amino acid and N2 (nitrogen number two) of another alpha amino acid along a peptide chain. In some embodiments, the peptides that can be employed for chlorine scavenger can include from 5 to 150 amino acid chains within the molecule. Peptides including amino acid chains that are less than 5 or larger than 150 amino acids are contemplated in the present disclosure as long as the peptide that is used has chlorine scavenging capability. Illustrative examples of peptides that can be used as the second chlorine scavenger include, but are not limited to polylysine, polyarginine, and glutathione.

In the present disclosure, the laundry detergent composition (liquid or unit dose form) can include from about 0.025 percent by weight to about 2 percent by weight of a second chlorine scavenger. In some embodiments, the laundry detergent composition (liquid or unit dose form) of the present disclosure includes from about 0.05 weight percent to about 1.5 weight percent of the second chlorine scavenger.

In the liquid laundry detergent composition and in the unit dose laundry detergent composition, a weight ratio of the first chlorine scavenger to the second chlorine scavenger is from about 10:1 to about 1:2, with a weight ratio of the first chlorine scavenger to the second chlorine scavenger from about 5:1 to about 1:1 being preferred.

As stated above, the laundry detergent composition (liquid or unit dose form) of the present disclosure further includes at least one surfactant. Notably, the laundry detergent composition of the present disclosure includes, in addition to the first and second chlorine scavengers, a surfactant or a combination of surfactants. The at least one surfactant is typically present in the laundry detergent composition in an amount from about 5 weight percent to about 70 weight percent, with an amount from about 15 weight percent to about 65 weight percent being more typically, and with an amount from about 20 weight percent to about 50 weight percent being even more typical.

The at least one surfactant can include an anionic surfactant, a non-ionic surfactant, a cationic surfactant, a semi-polar surfactant, a zwitterionic surfactant or combinations thereof. In some embodiments, the surfactant includes one or more anionic surfactants and one or more non-anionic surfactants. In embodiments in which two or more surfactants are employed, the combination of surfactants can be referred to as a surfactant system. In some embodiments, the at least one surfactant used in the present application does not include LAS. In other embodiments, LAS can be used.

In some embodiments, the at least one surfactant is an anionic surfactant. When an anionic surfactant is present, the anionic surfactant is typically present in the laundry detergent composition in an amount from about 2 weight percent to about 35 weight percent, with an amount from amount from about 8 weight percent to about 25 weight percent being more typical, and an amount from about 15 weight percent to about 20 weight percent being even more typical. Non-limiting examples of anionic surfactants that can be employed in the present disclosure include sulfates and sulfonates, in particular, linear alkylbenzenesulfonates (LAS), isomers of LAS, branched alkylbenzenesulfonates (BABS), phenylalkanesulfonates, alpha-olefinsulfonates (AOS), olefin sulfonates, alkene sulfonates, alkane-2,3-diylbis(sulfates), hydroxyalkanesulfonates and disulfonates, alkyl sulfates (AS) such as sodium dodecyl sulfate (SDS), fatty alcohol sulfates (FAS), primary alcohol sulfates (PAS), alcohol ethersulfates (AES or AEOS or FES, also known as alcohol ethoxysulfates or fatty alcohol ether sulfates), secondary alkanesulfonates (SAS), paraffin sulfonates (PS), ester sulfonates, sulfonated fatty acid glycerol esters, alpha-sulfo fatty acid methyl esters (alpha-SFMe or SES) including methyl ester sulfonate (MES), alkyl- or alkenylsuccinic acid, dodecenyl/tetradecenyl succinic acid (DTSA), fatty acid derivatives of amino acids, diesters and monoesters of sulfo-succinic acid or salt of fatty acids (soap), or combinations thereof. In some embodiments, the laundry detergent composition of the present disclosure employs sodium laureth sulfate as the anionic surfactant. In some embodiments, LAS is excluded from the laundry detergent composition of the present disclosure.

In some embodiments, the at least one surfactant is a nonionic surfactant. When a nonionic surfactant is present, the nonionic surfactant is typically present in the laundry detergent composition in an amount from about 2 weight percent to about 30 weight percent, with an amount from amount from about weight percent to about 25 weight percent being more typical, and an amount from about 15 weight percent to about 20 weight percent being even more typical. Non-limiting examples of nonionic surfactants that can be employed in the present disclosure include alcohol ethoxylates (AE or AEO), alcohol propoxylates, propoxylated fatty alcohols (PFA), alkoxylated fatty acid alkyl esters, such as ethoxylated and/or propoxylated fatty acid alkyl esters, alkylphenol ethoxylates (APE), nonylphenol ethoxylates (NPE), alkylpolyglycosides (APG), alkoxylated amines, fatty acid monocthanolamides (FAM), fatty acid diethanolamides (FADA), ethoxylated fatty acid monoethanolamides (EFAM), propoxylated fatty acid monoethanolamides (PFAM), polyhydroxyalkyl fatty acid amides, or N-acyl N-alkyl derivatives of glucosamine (glucamides, GA, or fatty acid glucamides, FAGA).

In some embodiments, the at least one surfactant is a cationic surfactant. When a cationic surfactant is present, the cationic surfactant is typically present in the laundry detergent composition in an amount from about 2 weight percent to about 35 weight percent, with an amount from amount from about 8 weight percent to about 25 weight percent being more typical, and an amount from about 15 weight percent to about 20 weight percent being even more typical. Non-limiting examples of cationic surfactants include alkyldimethylethanolamine quat (ADMEAQ), cetyltrimethylammonium bromide (CTAB), dimethyldistearylammonium chloride (DSDMAC), and alkylbenzyldimethylammonium, alkyl quaternary ammonium compounds, alkoxylated quaternary ammonium (AQA) compounds, ester quats, or combinations thereof.

In some embodiments, the laundry detergent composition of the present disclosure can include at least one semipolar surfactant. Non-limiting examples of semipolar surfactants include amine oxides (AO) such as alkyldimethylamineoxide, N-(coco alkyl)-N,N-dimethylamine oxide and N-(tallow-alkyl)-N,N-bis(2-hydroxyethyl)amine oxide, or combinations thereof. In some embodiments, the laundry detergent composition of the present disclosure can include at least one zwitterionic surfactant. Non-limiting examples of zwitterionic surfactants that can be employed include betaines such as alkyldimethylbetaines, sulfobetaines, or combinations thereof. When a semipolar surfactant and/or a zwitterionic surfactant are present, each of the semipolar surfactant and/or the zwitterionic surfactant is typically present in the laundry detergent composition in an amount from about 2 weight percent to about 35 weight percent, with an amount from amount from about 8 weight percent to about 25 weight percent being more typical, and an amount from about 15 weight percent to about 20 weight percent being even more typical.

In some embodiments, the at least one surfactant is a surfactant system that includes a fatty alcohol ethoxylate C₁₂₋₁₅ 7EO (non-ionic surfactant) and sodium laureth sulfate (anionic surfactant). Such surfactant systems are free of LAS.

As stated above, the laundry detergent composition (liquid or unit dose form) of the present disclosure further includes a carry-over enhancer. The carry-over enhancer is typically present in the laundry detergent composition in an amount from about 0.1 weight percent to about 5 weight percent, with an amount from about 0.5 weight percent to about 2.5 weight percent being more typically, and with an amount from about 1 weight percent to about 2 weight percent being even more typical. The carry-over enhancer includes any polymer that can be used to enhance the chlorine scavenger's ability to remove/eliminate chlorine for the water used during the rinse cycle. The carry-over enhancer that can be used in the present disclosure includes a performance polymer, a soil release polymer, an anti-redeposition polymer or any combination thereof.

A performance polymer is a polymer that prevents stains, even in cold and hard water conditions, while also keeping fabrics and colors bright. Illustrative examples of performance polymers that can be employed in the present disclosure as the carry-over enhancer include, but are not limited to, polyethyleneimine ethoxylate, propoxylate, ethoxylate/propoxylate and/or combinations thereof.

A soil release polymer (SRP) is a polymer that enables soil release from fabric and prevents soil redeposition during the washing cycle. SRPs make the fabric more soil-resistant. Illustrative SRPs that can be employed in the present disclosure as the carry-over enhancer include, but are not limited to, acrylic acid based polymers such as, for example. polyacrylate-based polymers, polymethacrylate-based polymers; fluorine-containing polymers; terephthalate-based polymers such as, for example, polyoxyethylene terephthalate polyesters; polysaccharide-based polymers such as, for example, cellulose-based polymers including carboxymethyl cellulose, hydroxyethyl cellulose, methylcellulose and hydroxypropyl cellulose.

An anti-redeposition polymer (ARD) is a polymer which helps minimize and avoid the redeposition of soil onto a fabric. The ARDs are usually water soluble and negatively charged polymers. The ARDs can interact and stabilize the soil in the wash water, thus preventing them from depositing back to the washed garment. There are two ways that these polymeric materials work: (1) the negatively charged ARDs adsorb on the surface of the garment causing an increase in the electrostatic repulsion between the hydrophobic soil molecules and the fabric surface and (2) entrapment of soil particles into a polymer matrix. The ARD can be based on acrylic acid, e.g., a homopolymer of acrylic acid, a poly carboxylate based on acrylic acid, a copolymer of acrylic acid and polystyrene, or a copolymer of maleic acid and acrylic acid. Examples of a suitable anti-redeposition agent include, e.g., sodium polyacrylate, modified polyethylene glycol, styrene-acrylic acid copolymer, polyethyleneimine, or a combination thereof. In some embodiments, the anti-redeposition agent comprises sodium polyacrylate.

Preferred embodiments of the carry-over enhancer include at least one of polyethyleneimine ethoxylate, propoxylate, ethoxylate/propoxylate, or terephthalate-based polymers such as, for example, polyoxyethylene terephthalate polyesters, and styrene-acrylic acid copolymers.

In the laundry detergent composition (liquid or unit dose form) of the present disclosure, a weight ratio of the at least one surfactant to the carry-over enhancer is from about 35:1 to about 5:1, with a weight ratio of the at least one surfactant to the carry-over enhancer from about 20:1 to about 10:1 being more typical.

The laundry detergent composition (liquid or unit dose form) of the present disclosure further includes water. The amount of water that is present in the laundry detergent composition can vary depending on whether the detergent composition is in unit dose form, or in liquid form. This will be described in greater detail herein.

In some embodiments of the present disclosure, the laundry detergent composition (liquid or unit dose form) of the present disclosure has a pH from 2 to 12. In other embodiments of the present disclosure, the laundry detergent composition of the present disclosure has a pH from 4 to 11. In some embodiments, a pH adjusting agent such as, for example, an acid (not limited to citric acid) and/or sodium hydroxide can be present in the laundry detergent composition of the present disclosure. The pH adjusting agent is present in an amount that is suitable for providing a desired pH to the laundry detergent composition (liquid or unit dose form) of the present disclosure. In some embodiments, the pH adjusting agent is present up to about up to about 3 weight percent, including from about 0.05 to about 2 weight percent, and including from about 0.1 to about 1 weight percent, and including from about 0.15 to about 1.5 weight percent, based on the total weight percent of the laundry detergent composition of the preset disclosure.

In addition to the above-mentioned components, the laundry detergent composition (liquid or unit dose form) of the present disclosure can include any additional detergent component(s) that is known in the art. Other optional detergent components include, for example, an amine source, rheology modifiers, beaching systems, dye transfer agents, anti-corrosion agents, anti-shrink agents, anti-wrinkling agents, bactericides, binders, corrosion inhibitors, disintegrants/disintegration agents, dyes, enzyme stabilizers (including boric acid, borates, CMC, and/or polyols such as propylene glycol), fabric conditioners including clays, fillers/processing aids, fluorescent whitening agents/optical brighteners, foam boosters, foam (suds) regulators, perfumes, softeners, suds suppressors, and wicking agents, either alone or in combination. Any component known in the art for use in detergents may be utilized. The choice of such optional components and the working amounts is well within the skill of the artisan. In some embodiments, the laundry detergent composition (liquid or unit dose form) of the present disclosure does not include a dye, a perfume, a preservative or any combination.

In some embodiments, the laundry detergent composition (liquid or unit dose form) of the present disclosure can also include a fatty acid that has a formula R—C(O) OH, wherein R is a C₅-C₂₁ linear or branched aliphatic group. In one example, the fatty acid is dodecanoic acid (also known as coconut fatty acid).

The laundry detergent composition (liquid or unit dose form) of the present disclosure can be formulated utilizing techniques well known to those skilled in the art. The various components that provide the laundry detergent composition (liquid or unit dose form) of the present disclosure can be added in any order. The addition is typically a metered addition. The addition of the various components that provide the laundry detergent composition of the present disclosure can be performed with continuous stirring. The addition is typically performed at room temperature, e.g., from about 20° C. to about 30° C.

In embodiments in which a liquid laundry detergent composition is provided, the liquid laundry detergent composition can contain at least 20 percent by weight and up to 95 percent by weight water, such as up to about 70 percent by weight water, up to about 65 percent by weight water, up to about 55 percent by weight water, up to about 45 percent by weight water, up to about 35 percent by weight water. Other types of solvents, besides water including, for example, organic solvents comprising alkanols, amines, diols, ethers and/or polyols can also be included in the liquid laundry detergent composition of the present disclosure. The organic solvent can be present in the liquid laundry detergent composition of the present disclosure in an amount from about 0 percent by weight, up to, and including, 30 percent by weight.

In some embodiments, the detergent composition of the present disclosure is in unit dose form. In such embodiments, a detergent product (i.e., the unit dose laundry detergent composition) is provided that includes a container and a detergent composition, as defined above, that includes a pre-determined dose of the detergent composition encapsulated in a container, where the detergent composition comprises, consists essentially of, or consists of, (a) monoethanolamine (MEA) as a first chlorine scavenger; (b) a second chlorine scavenger which is compositionally different from the first chlorine scavenger; (c) at least one surfactant; (d) a carry-over enhancer; and (e) water.

The container may be a pouch, a pod or a pack (or pac) made from a water-soluble or water-dispersible polymer film, which encloses the detergent composition of the present disclosure. The water-soluble or water-dispersible container can be in any desirable shape and size, e.g., square, rectangular, oval, elliptoid, super-elliptical, or circular shape.

The pre-determined dose of the laundry detergent composition is an amount of the laundry detergent composition which can be used in laundering of fabrics to provide chlorine scavenging, In one example, pre-determined dose is from about 0.001 g to about 1 kg per treatment.

As stated above, the container of the unit dose is formed from a water-soluble or water-dispersible polymer film. Non-limiting examples of water-soluble or water-dispersible polymers include polyvinyl alcohol, cellulose ethers, polyethylene oxide, starch, polyvinylpyrrolidone, polyacrylamide, polyacrylonitrile, polyvinyl methyl ether-maleic anhydride, polymaleic anhydride, styrene maleic anhydride, hydroxyethylcellulose, methylcellulose, polyethylene glycol, carboxymethylcellulose, polyacrylic acid salts, alginates, acrylamide copolymers, guar gum, casein, ethylene-maleic anhydride resins, polyethyleneimine, ethyl hydroxyethylcellulose, ethyl methylcellulose, hydroxyethyl methylcellulose, film forming cellulosic polymer, polyanhydride, polysaccharide, polyalkylene oxide, cellulose, cellulose ester, cellulose amide, polyvinyl acetate, polycarboxylic acid and salt, polyaminoacid, polyamide, natural gums, polyacrylate, water-soluble acrylate copolymer, methylcellulose, carboxymethylcellulose sodium, dextrin, ethylcellulose, maltodextrin, polymethacrylate, polyvinyl alcohol copolymer, and combinations thereof.

In some embodiments, the water-soluble or water-dispersible film material of the container may be polyvinyl alcohol, polyvinyl acetate, film forming cellulosic polymer, polyacrylic acid, polyacrylamide, polyanhydride, polysaccharide, or a mixture thereof. In one example, the water-soluble or water-dispersible film material is polyvinyl alcohol or polyvinyl acetate. In another example, the water-soluble or water-dispersible container is made from a lower molecular weight water-soluble polyvinyl alcohol film-forming resin.

In some embodiments, the water-soluble or water-dispersible container can further contain a cross-linking agent. In one embodiment, the cross-linking agent can be boric acid or sodium borate.

The film material on the container can have a thickness of between about 50 microns to about 120 microns, with a thickness between about 60 microns to about 100 microns being more typical.

The water-soluble or water-dispersible container of the unit dose embodiment can be prepared in any suitable way, such as via molding, casting, extruding or blowing, and is then filled using an automated filling process, as known in the prior art.

The laundry detergent composition that can be used in the unit dose embodiment includes (i) the laundry detergent composition of the present disclosure; and (ii) a solvent system. The solvent system can consist of water, a non-aqueous solvent (NAS), and a residual solvent present in an amount of 0 to 5 percent by weight of the liquid composition. In embodiments, the NAS can include a single NAS or more than one non-aqueous solvent can be employed. The residual solvent is neither water nor the NAS. Each of water and the NAS is present in an amount of more than 5 percent by weight of the liquid composition, with the solvent system totals from about 30% to about 80% by weight of the liquid composition.

In some embodiments, the solvent system comprises from about 37.5% to about 70%, preferably from about 40% to about 65%, and more preferably from about 50% to about 60%, based on the total weight of the detergent composition. In other embodiment, the solvent system is present in an amount of from 37.5% to about 40%, from about 40% to about 45%, from about 45% to about 50%, from about 50% to about 55%, from about 55% to about 60%, from about 60% to about 65%, from about 65% to about 70%, from about 70% to about 75%, or from about 75% to about 80%, by weight of the detergent composition.

Typically two or three non-aqueous solvents which are greater than 5% wt. are present in the liquid composition. In some embodiments, the NAS is typically present from about 10% to about 70%, more typically from about 20% to about 65%, even more typically from about 25% to about 60%, yet more typically from about 30% to about 55%, and still yet more typically from about 40% to about 55%, based on the total weight of the detergent composition.

In other embodiments, the NAS is present in an amount of from about 10% to about 20%, from 20% to about 30%, from about 30% to about 40%, from about 40% to about 50%, from about 50% to about 60%, from about 60% to about 70%, by weight of the detergent composition.

In some embodiments, the NAS is present in an amount of about 25%, from 22% to about 27%, from 28% to about 35%, from about 33% to about 43%, or from about 40% to about 45%, by weight of the detergent composition.

In some embodiments, the NAS may be chosen from ethanol; polyethylene glycol; polypropylene glycol; polypropylene glycol esters; polyethylene glycol esters such as polyethylene glycol stearate, polyethylene glycol laurate, and/or polyethylene glycol palmitate; methyl ester ethoxylate; diethylene glycol; dipropylene glycol; sorbitol; tetramethylene glycol; butylene glycol; pentanediol; hexylene glycol; heptylene glycol; octylene glycol; 2-methyl-1,3-propanediol; xylitol; mannitol; erythritol; dulcitol; inositol; adonitol; triethylene glycol; glycol ethers, such as ethylene glycol monobutyl ether, diethylene glycol monobutyl ether, triethylene glycol monobutyl ether, ethylene glycol monopropyl ether, diethylene glycol monoethyl ether, triethylene glycol monoethyl ether, diethylene glycol monomethyl ether, and triethylene glycol monomethyl ether; tris (2-hydroxyethyl)methyl ammonium methylsulfate; ethylene oxide/propylene oxide copolymers with the non-aqueous solvent has a weight average molecular weight of 4000 Daltons or less.

In some embodiments, the NAS is selected from polyethylene glycol; polyethylene glycol esters such as polyethylene glycol stearate, polyethylene glycol laurate, and/or polyethylene glycol palmitate; polyproylene glycol.

In some embodiments, the NAS is polyethylene glycol (“PEG”) and an ester thereof. The PEG can have a weight average molecular weight ranging, for example, from about 100 to about 4000 Daltons. Suitable PEGs can have a weight average molecular weight of, for example, about 300, about 400, about 500, about 600, about 700, about 800, about 900, about 1000, about 1100, about 1200, about 1300, about 1400, about 1500, about 1600, about 1700, about 1800, about 1900, about 2000, about 2100, about 2200, about 2300, about 2400, about 2500, or about 2600, about 2700, about 2800, about 2900, about 3000, about 3500, or about 4000 Daltons.

In some embodiments, the NAS is PEG 100 stearate, PEG 400, or PEG 3350. In other embodiments, the NAS is PEG 400 in an amount of from about 20% to about 45% by weight of the liquid composition; while water is present in an amount of from about 10% to about 30% by weight of the detergent composition.

The water in the laundry detergent composition of the unit-dose form can be derived from added water or water accompany a component that forms the raw material that is used in formulating the laundry detergent composition. The total water amount presented in the laundry detergent composition is typically from about 5% to about 45%, more typically from about 10% to about 40%, even more typically from about 15% to about 35%, still more typically from about 20% to about 40%, yet more typically from about 25% to about 35%, and even further typically from about 25% to about 30%, based on the total weight of the detergent composition.

In other embodiments, water is present in an amount of from about 5% to about 10%, from 10% to about 15%, from about 15% to about 20%, from about 20% to about 25%, from about 25% to about 30%, from 30% to about 35%, from about 35% to about 40%, or from about 40% to about 45%, by weight of the laundry detergent composition.

In some embodiments, water is present in an amount of from 11% to about 16%, from 17% to about 23%, or from about 22% to about 32%, by weight of the laundry detergent composition.

In some embodiments, the weight ratio of water to the NAS is from 1:4 to 4:1, from 1:3 to 3:1, from 1:3 to 2:1, from 1:2 to 2:1, or about 1:1. In other embodiments, the weight ratio of water to the NAS is from 1:1 to 4:1, from 1:1 to 3:1, or from 1:1 to 2:1. In further embodiments, the weight ratio of water to the NAS is about 0.5:1, about 0.8:1, about 1:1, about 1:1, about 1.2:1, about 1.3:1, or about 1.5:1.

The term “residual solvent(s)” generally refer to a solvent that is introduced into the detergent composition by the addition of an ingredient (i.e., a commercial product containing the ingredient and the residual solvent), where the residual solvent is less than 5% by weight (wt) of the detergent composition. In some embodiments, the residual solvent is less than 5% wt, or less than 3% wt, or less than 1% wt.

The residual solvent is neither water nor the NAS. In some embodiments, the residual solvent is a mono-ol or di-ol with a low Mw. For example, the residual solvent may be ethanol. The existence of the residual solvent does not interfere with the performances of the solvent system.

As mentioned above, the detergent composition is encapsulated in a container made of a water-soluble or water-dispersible film. The solubility of the polymeric film in water should be moderated to keep the film structurally sound prior to use. In some embodiments, the inclusion of a non-aqueous solvent of certain type in the detergent composition moderates the solubility of the film, thereby protecting the film from being dissolved by water incorporated in the detergent composition. As such, adding the non-aqueous solvent to the detergent composition allows for unit dose pacs where the detergent composition therein includes water present in amounts of up to about 45%, by the weight of the detergent composition. It also allows for unit dose pacs where the detergent composition therein includes contain a high total solvent content, up to about 80%, by the weight of the detergent composition without compromising pac rigidity.

The laundry detergent composition (liquid or unit dose form) of the present disclosure can be used to treat fabrics or textiles, for example, to provide chlorine scavenging during the laundering of a fabric or textile.

In one aspect, the present disclosure provides a method of treating a fabric or a textile comprising combining or contacting the fabric or textile to be treated, with water and the laundry detergent composition (liquid or unit dose form) in accordance with the present disclosure. The laundry detergent composition can be in unit dose form (i.e., in a container as described above) or used as is, i.e., in liquid form. The amount of laundry detergent composition can be, for example, about 0.001 g to about 1 kg per treatment. The amount of the laundry detergent composition can be, for example, about 0.01 g, about 0.1 g, about 1 g, about 2 g, about 3 g, about 4 g, about 5 g, about 6 g, about 7 g, about 8 g, about 9 g, about 10 g, about 25 g, about 50 g, about 100 g, about 200 g, about 300 g, about 400 g, about 500 g, about 600 g, about 700 g, about 800 g, or about 900 g per treatment.

The laundry detergent composition (liquid or unit dose form) can be used in a top loading or front loading washer, in hot, warm, or cold water. The laundry detergent composition can be used in both a wash cycle and a rinse cycle.

In one aspect, the disclosure provides a textile treated by a laundry detergent composition (liquid or unit dose form), as disclosed herein.

In one aspect, the laundry detergent composition can be added to an amount of water or wash liquor in which a textile is washed by hand.

The textile, after being treated, can be further processed, for example by drying, pressing, ironing, steaming, sewing, and the like.

Examples have been set forth below for the purpose of further illustrating the present disclosure. The scope of the present disclosure is not limited to any of the examples set forth herein. All compositions described below are given in % weight of each material included in the formula.

### Example 1

Table 1 includes comparative (labeled as “Control”) and inventive formulas for non-unit dose detergents.

TABLE 1

| | Raw | Wt % of | Wt % of | Wt % of |
|---|---|---|---|---|
| | Material | Formula 1 | Formula 2 | Formula 3 |
| Component | Activity | (Control) | (Control) | (Inventive) |
| Water, demineralized | 100 | q/s to 100 | q/s to 100 | q/s to 100 |
| | | (about 75) | (about 73) | (about 74) |
| Citric acid | 50 | 1.0 | 1.0 | 1.0 |
| Sodium Hydroxide | 50 | As needed | As needed | As needed |
| | | to adjust | to adjust | to adjust |
| | | to pH 7.6 | to pH 7.6 | to pH 7.6 |
| Fatty alcohol | 100 | 5.7 | 5.7 | 5.7 |
| ethoxylate (C₁₂-C₁₅, | | | | |
| 7 EO) | | | | |
| Sodium Laureth | n/a | 12 | 12 | 12 |
| Sulfate, 3EO/Linear | | | | |
| Alkylbenzene | | | | |
| Sulfonic Acid | | | | |
| Palm Kernel Oil | 100 | 0.5 | 0.5 | 0.5 |
| Fatty Acid | | | | |
| Monoethanolamine | 100 | 0.625 | 1.25 | 0.625 |
| Lysine-HCl | 80 (of | 0 | 0 | 0.38 |
| | Lysine) | | | |
| Styrene/Acrylic Acid | 37 | 0.55 | 0.55 | 0.55 |
| Copolymer | | | | |
| Boric Acid, Chelant, | N/A | 3.95 | 3.95 | 3.95 |
| Polyethyleneimine | | | | |
| Ethoxylate | | | | |

A multi-wash study was conducted using the detergents described in Table 1. The target dose of detergent per wash was 45 grams, and the estimated amount of water in the Speed Queen AWN412 Standard Top Loader washing machine was 62.5 L for the wash cycle and 62.5 L for the rinse cycle. The starting chlorine concentration (hypochlorite) for both the wash water and rinse water was 1 ppm. A warm wash at ˜32° C. was conducted for 12 minutes, followed by a subsequent rinse cycle at 15° C. About 2.5 kg of cotton ballast was used for the evaluation. Standard 100% cotton woven colored fabrics (Blue Vat 4, Black Reactive 5) were used to assess detergent performance. Five wash cycles were conducted using three swatch replicates per dye type. A high heat tumble dry cycle was conducted after each wash cycle for 60 minutes before proceeding to the next wash cycle.

The total color change (delta E) was measured using a spectrophotometer. The scope of color change of color swatches after 1 to 5 washes were captured and depicted in Table 2. “DE” means “Delta E”, a.k.a., ΔE. A lower ΔE is indicative of improved color care performance.

The results are described in Table 2. The total color change observed for both color swatches using the inventive formula 3 (low MEA+lysine) is higher than the control formula 1 (low MEA), and similar to the control formula 2 (high MEA). This demonstrates a synergistic performance of lysine with MEA, allowing for lower doses of MEA to be used while still achieving effective color protection for fabrics.

TABLE 2

| | | Black Reactive |
|---|---|---|
| | Blue Vat 4 Cotton | 5 (1%) Cotton |
| | Swatch Color Change | Swatch Color Change |
| Formula | After 5 Washes (ΔE) | After 5 Washes (ΔE) |
| 1 (control, low MEA) | 5.5 | 1.2 |
| 2 (control, high MEA) | 3.7 | 0.4 |
| 3 (inventive, low | 4.2 | 0.5 |
| MEA + low lysine) | | |

As can been seen from Table 2, adding a second chlorine scavenger such as lysine unexpectedly retain colors of color swatches, which suggests the synergistic effect of combining the anionic surfactant and/or the carry-over enhancer and the chlorine scavengers in the compositions.

### Example 2

The Table 3 includes comparative (labeled as “Control”) and inventive formulas for unit dose detergents.

TABLE 3

| | Raw | Wt % of | Wt % of | Wt % of |
|---|---|---|---|---|
| | Material | Formula 4 | Formula 5 | Formula 6 |
| COMPONENT | Active % | (Control) | (Control) | (Inventive) |
| Glycerine | 100 | 11.9 | 10.7 | 10.5 |
| Alkyl Ethoxysulfate, | n/a | 32.5 | 32.5 | 32.5 |
| Linear Alkylbenzene | | | | |
| Sulfonic Acid | | | | |
| Fatty alcohol | 100 | 16.0 | 16.0 | 16 |
| ethoxylate (C12-C15, | | | | |
| 7 EO) | | | | |
| Monoethanolamine | 100 | 3.5 | 7.0 | 3.5 |
| Lysine-HCl | 80 (of | 0 | 0 | 2.2 |
| | lysine) | | | |
| Water | 100 | 5.7 | 8.0 | 6.4 |
| NaOH | 50 | 4.6 | 0 | 3.1 |
| Palm Kernel Oil | 100 | 5.5 | 5.5 | 5.5 |
| Fatty Acid | | | | |
| Polyethyleneimine | 80 | 1.5 | 1.5 | 1.5 |
| Ethoxylate | | | | |
| Polyoxyethylene | 70 | 2.5 | 2.5 | 2.5 |
| Terephthalate | | | | |
| Ethanol, PEG 400, | n/a | 13.0 | 13.0 | 13.0 |
| Propylene Glycol | | | | |
| Mannanase, Amylase, | n/a | 3.2 | 3.2 | 3.2 |
| Cellulase, Optional | | | | |
| Protease, Optical | | | | |
| Brightener, Bitrex in | | | | |
| propylene glycol, | | | | |
| chelant, NaOH | | | | |

A multi-wash study was conducted using the detergents described in Table 3. The target dose of detergent per wash was 17.5 grams, and the estimated amount of water in the programmable deep fill top loader washing machine was 62.5 L for the wash cycle and 62.5 L for the rinse cycle. The starting chlorine concentration (hypochlorite) for both the wash water and rinse water was 1 ppm. A warm wash at ˜32° C. was conducted for 12 minutes, followed by a subsequent rinse cycle at 15° C. About 2.5 kg of cotton ballast was used for the evaluation. Standard 100% cotton woven colored fabrics (Blue Vat 4, Black Reactive 5) were used to assess detergent performance. Five wash cycles were conducted using three swatch replicates per dye type. A high heat tumble dry cycle was conducted after each wash cycle for 60 minutes before proceeding to the next wash cycle.

TABLE 4

| | Blue Vat 4 Cotton | Black Reactive 5 |
|---|---|---|
| | Swatch Color | Cotton Swatch Color |
| | Change After 5 | Change After 5 |
| Formula | Washes (ΔE) | Washes (ΔE) |
| 4 (control, low MEA) | 2.5 | 1.6 |
| 5 (control, high MEA) | 1.3 | 1.5 |
| 6 (inventive, low MEA + | 1.4 | 1.6 |
| low lysine) | | |

As can been seen from Table 4, adding a second chlorine scavenger such as lysine unexpectedly retain colors of color swatches, which suggests the synergistic effect of combining the anionic surfactant and/or the carry-over enhancer and the chlorine scavengers in the compositions.

### Example 3

Inventive Formula 7 is described in Table 3 and was prepared with the materials listed in Table 1. The final pH of Formula 7 can be adjusted with an acid (not limited to citric) and/or sodium hydroxide to be between 2 and 12.

TABLE 3

| | Raw | Wt % of |
|---|---|---|
| | Material | Formula 7 |
| Component | Activity | (Inventive) |
| Water, demineralized | 100 | q/s to 100 |
| Citric acid | 50 | 0.05 to 4 |
| Sodium Hydroxide | 50 | 0 to 4 |
| Fatty alcohol ethoxylate | N/A | 5 to 30 |
| (C₁₂-C₁₅, 7 EO), Sodium Laureth | | |
| Sulfate (3 EO) | | |
| Linear Alkylbenzene Sulfonic Acid | 96 | 3 to 21 |
| Palm Kernel Oil Fatty Acid | 100 | 0.1 to 4 |
| Monoethanolamine | 100 | 0.1 to 6 |
| Lysine-HCl | 80 (of | 0.1 to 3 |
| | Lysine) | |
| Carry-Over enhancer (e.g. | 30 to 100 | 0 to 6 |
| styrene/acrylic acid copolymer) | | |
| Misc., such as Boric Acid, Propylene | N/A | 3 to 15 |
| Glycol, Chelant, Anti-redeposition | | |
| Polymer, Optical Brightener, Aqueous | | |
| Enzyme Solution (one or more of | | |
| Protease, Amylase, Mannanase, | | |
| Cellulase blend), Colorant, Fragrance | | |

### Example 4

Inventive Formula 3 as described in Table 1 and Table 4 can further be compared against Formula 8 and Formula 9 as described in Table 4. Formula 5 was prepared with the amount of lysine present in Formula 8, but does not contain MEA. Formula 9 contains the molar equivalent scavenger as Formula 3, with the amount of lysine in Formula 3 converted to MEA. In alternative embodiments, Formula 3 may be free of carry-over enhancers.

TABLE 4

| | Raw | Wt % of | Wt % of | Wt % of | Wt % of | Wt % of |
|---|---|---|---|---|---|---|
| | Material | Formula 1 | Formula 2 | Formula 3 | Formula 8 | Formula 9 |
| Component | Activity | (Control) | (Control) | (Inventive) | (Inventive) | (Control) |
| Water, demineralized | 100 | q/s to 100 | q/s to 100 | q/s to 100 | q/s to 100 | q/s to 100 |
| | | (about 75) | (about 73) | (about 74) | (about 74) | (about 74) |
| Citric acid | 50 | 1.0 | 1.0 | 1.0 | 1.0 | 1.0 |
| Sodium Hydroxide | 50 | As needed | As needed | As needed | As needed | As needed |
| | | to adjust | to adjust | to adjust | to adjust | to adjust |
| | | to pH 7.6 | to pH 7.6 | to pH 7.6 | to pH 7.6 | to pH 7.6 |
| Fatty alcohol | 100 | 5.7 | 5.7 | 5.7 | 5.7 | 5.7 |
| ethoxylate | | | | | | |
| (C₁₂-C₁₅, 7 EO) | | | | | | |
| Sodium Laureth | 70 | 12 | 12 | 12 | 12 | 12 |
| Sulfate, 3EO / Linear | | | | | | |
| Alkylbenzene | | | | | | |
| Sulfonic Acid | | | | | | |
| Palm Kernel Oil Fatty | 100 | 0.5 | 0.5 | 0.5 | 0.5 | 0.5 |
| Acid | | | | | | |
| Monoethanolamine | 100 | 0.625 | 1.25 | 0.625 | 0 | 0.76 |
| Styrene/Acrylic Acid | 37 | 0.55 | 0.55 | 0.55 | 0.55 | 0.55 |
| Copolymer | | | | | | |
| Lysine-HCl | 80 | 0 | 0 | 0.38 | 0.38 | 0 |
| Boric Acid, Chelant, | N/A | 4.5 | 4.5 | 4.5 | 4.5 | 4.5 |
| Anti-redeposition | | | | | | |
| Polymer, Soil-release | | | | | | |
| Polymer | | | | | | |

The total inclusion level of lysine (or another amino acid with scavenging potential or peptide with sequence length of 5 to 150 amino acids or sugar amine such as glucosamine) and MEA in the formula can range from 0.25 to 4% of the formula, LAS (or another surfactant charged or uncharged) from 3 to 45%, and carry-over enhancer from 0 to 4%, all on an active content. Ratio of lysine to MEA can range from 1:99 to 99:1. The ratio of total lysine and MEA to surfactant to carry over-enhancer can fall within the ratios above.

While the present disclosure has been particularly shown and described with respect to preferred embodiments thereof, it will be understood by those skilled in the art that the foregoing and other changes in forms and details may be made without departing from the spirit and scope of the present disclosure. It is therefore intended that the present disclosure not be limited to the exact forms and details described and illustrated, but fall within the scope of the appended claims.

What is claimed is:

1. A liquid laundry detergent composition comprising:
(a) monoethanolamine (MEA) as a first chlorine scavenger;
(b) a second chlorine scavenger which is compositionally different from the first chlorine scavenger;
(c) at least one surfactant;
(d) a carry-over enhancer; and
(e) water.

2. The liquid laundry detergent composition of claim 1, wherein a weight ratio of the first chlorine scavenger to the second chlorine scavenger is from about 10:1 to about 1:2.

3. The liquid laundry detergent composition of claim 1, wherein a weight ratio of the at least one surfactant to the carry-over enhancer is from about 35:1 to about 5:1.

4. The liquid laundry detergent composition of claim 1, wherein the second chlorine scavenger comprises an amino acid, a sugar amide, a peptide or any combination thereof.

5. The liquid laundry detergent composition of claim 1, wherein the second chlorine scavenger is lysine or threonine.

6. The liquid laundry detergent composition of claim 1, wherein the carry-over enhancer is present in an amount from about 0.1 weight percent to about 5 weight percent.

7. The liquid laundry detergent composition of claim 1, wherein the carry-over enhancer comprises a performance polymer, a soil release polymer, an anti-redeposition polymer or any combination thereof.

8. The liquid laundry detergent composition of claim 1, wherein the at least one surfactant is present in an amount from about 5 weight percent to about 70 weight percent.

9. The liquid laundry detergent composition of claim 1, wherein the at least one surfactant is an anionic surfactant.

10. The liquid laundry detergent composition of claim 1, wherein the composition contains at least 20 percent by weight and up to 95 percent by weight water.

11. A unit dose laundry detergent composition comprising:
a pre-determined dose of a laundry detergent composition encapsulated in a container, wherein the laundry detergent composition comprises:
(a) monoethanolamine (MEA) as a first chlorine scavenger;
(b) a second chlorine scavenger which is compositionally different from the first chlorine scavenger;
(c) at least one surfactant;
(d) a carry-over enhancer; and
(e) water, wherein container comprises a water-soluble polymer or water-dispersible polymer.

12. The unit dose laundry detergent composition of claim 11, wherein a weight ratio of the first chlorine scavenger to the second chlorine scavenger is from about 10:1 to about 1:2.

13. The unit dose laundry detergent composition of claim 11, wherein a weight ratio of the at least one surfactant to the carry-over enhancer is from about 35:1 to about 5:1.

14. The unit dose laundry detergent composition of claim 11, wherein the second chlorine scavenger comprises an amino acid, a sugar amide, a peptide or any combination thereof.

15. The unit dose laundry detergent composition of claim 11, wherein the second chlorine scavenger is lysine or threonine.

16. The unit dose laundry detergent composition of claim 11, wherein the carry-over enhancer is present in an amount from about 0.1 weight percent to about 5 weight percent.

17. The unit dose laundry detergent composition of claim 11, wherein the carry-over enhancer comprises a performance polymer, a soil release polymer, an anti-redeposition polymer or any combination thereof.

18. The unit dose laundry detergent composition of claim 11, wherein the at least one surfactant is present in an amount from about 5 weight percent to about 70 weight percent.

19. The unit dose laundry detergent composition of claim 11, wherein the at least one surfactant is an anionic surfactant.

20. The unit dose laundry detergent composition of claim 11, wherein the composition contains at least 5 percent by weight to 45 percent by weight water.
